(19) United States
(12) Patent Application Publication
(10) Pub. No.: US 2003/0044673 A1
(43) Pub. Date: Mar. 6, 2003

(54) Electrode for solid polymer fuel cells

(76) Inventors: Kaoru Fukuda, Wako-shi (JP); Shinya Watanabe, Wako-shi (JP); Chikara Iwasawa, Wako-shi (JP); Tadahiro Shiba, Wako-shi (JP); Yuichiro Sugiyama, Wako-shi (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/229,276

(22) Filed: Aug. 28, 2002

(30) Foreign Application Priority Data
Aug. 31, 2001 (JP) 2001-263090
Aug. 31, 2001 (JP) 2001-263095

(51) Int. Cl. H01M 4/86; H01M 4/92

(52) U.S. Cl. 429/42; 429/44

(57) ABSTRACT

An electrode for solid polymer fuel cells is capable of generating electric power at high output and high efficiency, without increasing the consumption of catalyst substance. By measurement of X-ray diffraction of catalyst substance of the electrode surface, the ratio I (111)/I (200) of peak intensity I (111) of (111) plane and peak intensity I (200) of (200) plane is 1.7 or less.

### BACKGROUND OF THE INVENTION

1. Field of the Invention

The present invention relates to an electrode for solid polymer fuel cells, and more particularly relates to a technology for improving catalyst function.

2. Description of the Related Art

A solid polymer fuel cell is composed by laminating separators at both sides of a tabular membrane electrode assembly (MEA). The membrane electrode assembly is generally a laminated body having a polymer electrolyte membrane placed between a positive side electrode catalyst layer and a negative side electrode catalyst layer, and having a gas diffusion layer laminated at the outside of each electrode catalyst layer. According to such fuel cell, for example, by passing hydrogen gas in a gas passage of the separator disposed at the negative electrode side, and by passing an oxidizing gas in a gas passage of the separator disposed at the positive electrode side, an electrochemical reaction occurs, and an electric current is generated.

During operation of the fuel cell, the gas diffusion layer transmits electrons generated by electrochemical reaction between the electrode catalyst layer and the separator, and diffuses the fuel gas and oxidizing gas at the same time. The negative side electrode catalyst layer induces a chemical reaction in the fuel gas to generate protons (H⁺) and electrons, and the positive side electrode catalyst layer produces water from oxygen, protons and electrons, while the electrolyte membrane transmits the protons by ion conduction. Electric power is thereby obtained through the positive and negative electrode catalyst layers. Herein, the electrode catalyst layer is composed of a catalyst paste having mixed therein carbon particles carrying catalyst particles made of a platinum group metal such as Pt on the surface and an electrolyte comprising ion conductive polymer, and the electrochemical reaction is believed to take place in a three-phase interface in which catalyst, electrolyte and gas coexist.

In the catalyst paste obtained in the conventional process of mixing carbon particles carrying catalyst particles, and electrolyte comprising ion conductive polymer, the utilization rate of catalyst particles in the electrochemical reaction tended to be lower. Accordingly, carbon particles carrying catalyst particles were used in greater amount than necessary, and since the catalyst particles are made of expensive platinum group metals such as Pt, as a result, the cost was extremely disadvantageously high.

### SUMMARY OF THE INVENTION

An object of the present invention is to provide an electrode for solid polymer fuel cells capable of generating power at high output and high efficiency without increasing the amount of catalyst used.

The present inventors intensively researched in order to achieve the object and noted the X-ray diffraction measured value of the catalyst substance of the electrode surface as a parameter, and discovered a specific range of measured values in which the catalyst activity is high, the consumption of the catalyst substance is less than previously, and the electrode generating electric power at higher efficiency is obtained. The present invention is based on this finding, and discloses an electrode for solid polymer fuel cells comprising a catalyst substance, electroconductive particles, and an ion conductive polymer, in which the ratio I (111)/I (200) of peak intensity I (111) of (111) plane and peak intensity I (200) of (200) plane is 1.7 or less when the X-ray diffraction of catalyst substance of the electrode surface is measured.

The present invention can be demonstrated by measurement of the absolute value of Tafel slope. As shown in FIG. 1, the Tafel slope is a declining inclination of I-V (current density-voltage) curve in the low current region, and when an I-V curve is plotted on the logarithmic scale of current density, a straight line is formed in the low current region. When the inclination of the straight line in this linear region is small, the catalyst activity is high, or when the inclination is large, the catalyst activity is small. In the embodiments given below, the calculation range estimates the inclination in the range of 0.003 to 0.1 A/cm², and it is known that the inclination is smaller than in the prior art when the ratio of the peak intensity is 1.7 or less.

As the catalyst substance to be used in the present invention, a platinum group metal, in particular, platinum, is preferred. By feeding the catalyst substance both before and after the electrode catalyst layer forming process, the electrode of the present invention can be manufactured favorably. In such a case, therefore, the catalyst substance is composed of catalyst substance A to be supplied before forming the electrode catalyst layer, and catalyst substance B to be supplied after forming the electrode catalyst layer.

In the case in which the catalyst substance A is supplied before forming the electrode catalyst layer, after mixing a catalyst precursor substance, electroconductive particles and ion conductive polymer, the catalyst precursor substance may be chemically reduced, or in the case in which the catalyst substance B is supplied after forming the electrode catalyst layer, a catalyst substance dispersed in an aqueous solution may be sprayed and applied on the surface of the electrode catalyst layer at the side contacting with the electrolyte membrane.

Furthermore, the inventors intensively researched the electric charge amount of the catalyst substance measured in a both-side humidifying method and a one-side humidifying method as the parameter, and discovered that catalyst activity is high when the electric charge amount in the one-side humidifying method is 15% or more of the electric charge amount in the both-side humidifying method, and hence that the consumption of the platinum group metal used as the catalyst substance may be reduced from the conventional level, thereby obtaining an electrode capable of generating electric power at higher efficiency. Therefore, when the membrane electrode assembly for solid polymer fuel cells is manufactured by laminating the electrode for solid polymer fuel cells of the present invention as an electrode catalyst layer on one side or both sides of the electrolyte membrane, the rate of the electric charge of catalyst substance existing in an ion conduction passage from the electrolyte membrane measured by a cyclic voltametric method is preferred to be 15% or more of the electric charge of the total catalyst substance existing in the electrode catalyst layer.

The above cyclic voltametric method (electrochemical surface area measuring method of catalyst substance) is explained below. In an ordinary cyclic voltametric method, as shown in FIG. 2A, a humidifying gas is supplied to both a cathode (positive electrode) 2 and an anode (negative electrode) 3 of a membrane electrode assembly 4 in which the electrodes 2 and 3 compose electrode catalyst layers at both sides of an electrolyte membrane 1, and an electric charge amount is measured on the basis of the electrochemical surface area of all catalyst substances in the electrode catalyst layer. In this case, humidifying gas is supplied to both electrodes 2 and 3, and this is the both-side humidifying method, and hence water permeates in all areas in the cell, and all catalyst substances existing in the electrode catalyst layer are objects of measurement.

In contrast, in the cyclic voltametric method shown in FIG. 2B, by humidifying only from the anode 3, the electric charge amount of the catalyst substance is measured, and hence this is the one-side humidifying method. In this one-side humidifying method, the water supplied from the anode 3 disperses only through the conduction passage of the ion conductor at the cathode 2 side. Hence, in the ion conduction passage in the cathode 2, the catalyst substance existing at the interface of the electrolyte membrane and electrode (electrode catalyst layer) is the main object of measurement.

This aspect of the present invention can be also demonstrated by measurement of the absolute value of Tafel slope. According to this measurement, when the rate of the electric charge of the catalyst substance existing in the ion conduction passage from the electrolyte membrane measured by the cyclic voltammetric method is 15% or more of the electric charge of the total catalyst substances existing in the electrode catalyst layer, it is disclosed that the inclination of the straight line in the linear region of the I-V curve is smaller than in the prior art.

### BRIEF DESCRIPTION OF THE DRAWINGS

FIG. 1 is an explanatory diagram of Tafel slope;

FIG. 2A is a conceptual diagram of the both-side humidifying method in the cyclic voltametric method, and FIG. 2B is a conceptual diagram of the one-side humidifying method in the cyclic voltametric method;

FIG. 3 is a diagram showing the relationship of the current density and the generated voltage in Examples of the present invention;

FIG. 4 is a diagram showing the relationship of the absolute value of Tafel slope and the peak intensity ratio I (111)/I (200) in Examples of the present invention;

FIG. 5 is a diagram showing the relationship of the platinum amount and the total electric charge of catalyst substance in Examples of the present invention;

FIG. 6 is a diagram showing the relationship of the platinum amount and the interface electric charge of catalyst substance in Examples of the present invention;

FIG. 7 is a diagram showing the relationship of the absolute value of Tafel slope and the ratio of the interface electric charge to total electric charge of the catalyst substance in Examples of the present invention; and

FIG. 8 is a diagram showing the relationship of the current density and the generated voltage in Examples of the present invention.

### DESCRIPTION OF THE PREFERRED EMBODIMENTS

The present invention is more specifically described below by referring to preferred embodiments.

### EXAMPLE 1

100 g of ion conductive polymer (trade name: Nafion SE5112, produced by Du Pont Kabushiki Kaisha), 5 g of Ketienblack EC, and 27.4 g of 10% [Pt(NO₂)₂(NH₃)₂] nitric acid aqueous solution as catalyst precursor substance were mixed, an ethanol solution was added to this mixture to reduce it, and a catalyst paste was obtained. This catalyst paste was applied and dried on a sheet of FEP (tetrafluoroethylene-hexafluoropropylene copolymer), and an electrode sheet A was obtained. The platinum content in this electrode sheet A was 0.30 mg/cm². 1 g of platinum black (trade name: HiSPEC1000, produced by Johnson Matthey Japan Incorporated) was dissolved in 100 g of purified water, this platinum black solution was sprayed and applied on the electrode sheet A by a spray method, and an electrode sheet B of Example 1 was obtained. The platinum content in this electrode sheet B was 0.35 mg/cm². As a result of X-ray diffraction measurement of platinum on the surface of the electrode sheet B in Example 1, the ratio I (111)/I (200) of peak intensity I (111) of (111) plane and peak intensity I (200) of (200) plane was 1.4.

### EXAMPLE 2

An electrode sheet B of Example 2 was obtained in the same manner as in Example 1 except that 46.2 g of the 10% [Pt(NO₂)₂(NH₃)₂] nitric acid aqueous solution was used. As a result of X-ray diffraction measurement of platinum on the surface of the electrode sheet B in Example 2, the peak intensity ratio I (111)/I (200) was 1.6.

### EXAMPLE 3

An electrode sheet B of Example 3 was obtained in the same manner as in Example 1 except that 13.7 g of the 10% [Pt(NO₂)₂(NH₃)₂] nitric acid aqueous solution was used. As a result of X-ray diffraction measurement of platinum on the surface of the electrode sheet B in Example 3, the peak intensity ratio I (111)/I (200) was 1.2.

### COMPARATIVE EXAMPLE 1

An electrode sheet B of Comparative Example 1 was obtained in the same manner as in Example 1 except that the catalyst paste was prepared by mixing 100 g of ion conductive polymer (trade name: Nafion SE5112, produced by Du Pont Kabushiki Kaisha), and 10 g of platinum carrying carbon particles (trade name: TE10E50E, produced by Tanaka Kikinzoku Kogyo K.K) of carbon black and platinum at a ratio of 50:50 by weight. As a result of X-ray diffraction measurement of platinum on the surface of the electrode sheet B in Comparative Example 1, the peak intensity ratio I (111)/I (200) was 1.9.

### COMPARATIVE EXAMPLE 2

An electrode sheet B of Comparative Example 2 was obtained in the same manner as in Example 1 except that 76.1 g of the 10% [Pt(NO₂)₂(NH₃)₂] nitric acid aqueous solution was used. As a result of X-ray diffraction measurement of platinum on the surface of the electrode sheet B in Comparative Example 2, the peak intensity ratio I (111)/I (200) was 1.8.

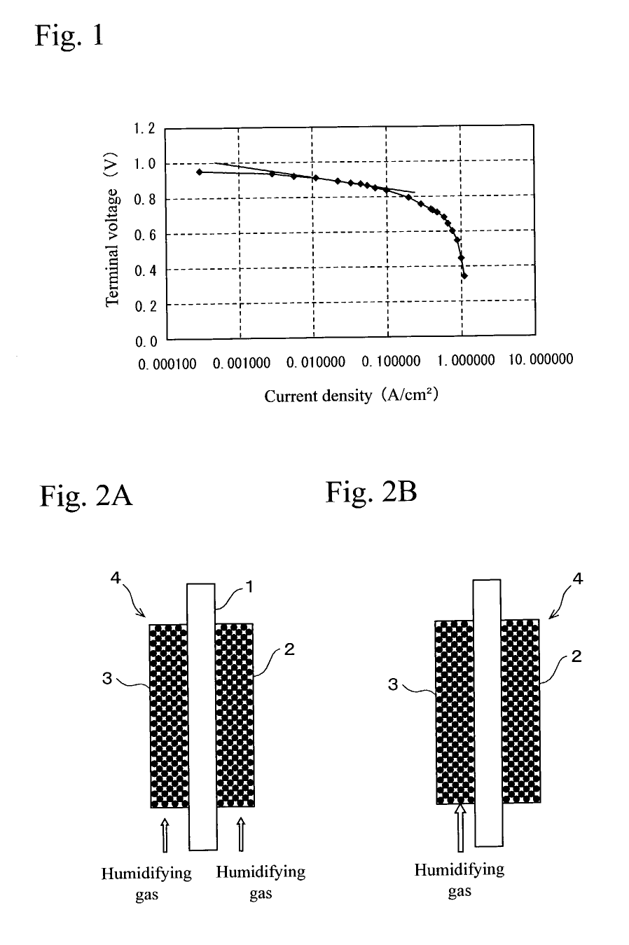

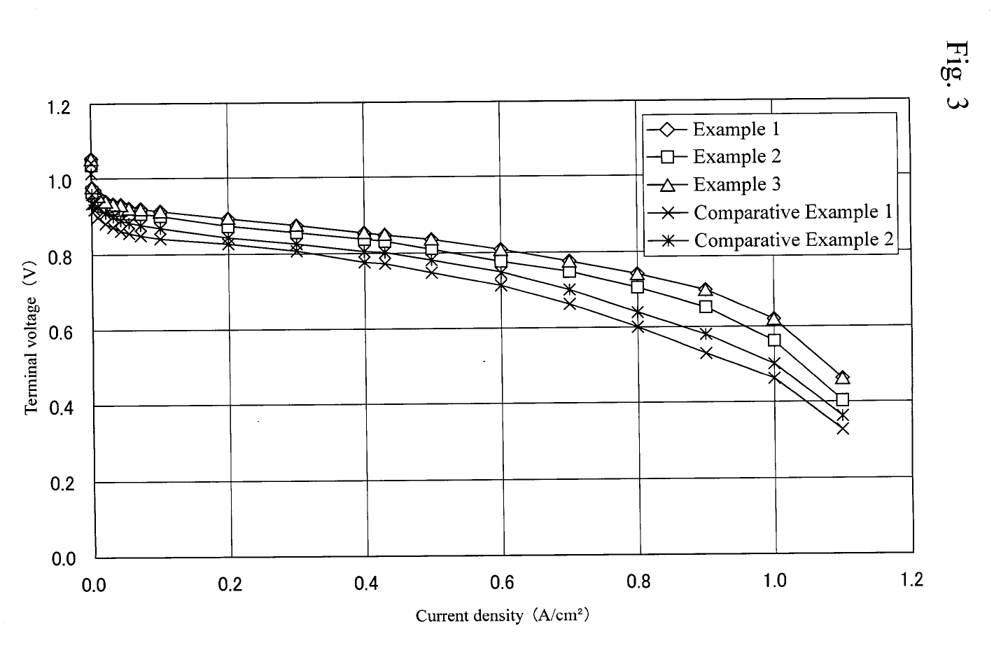

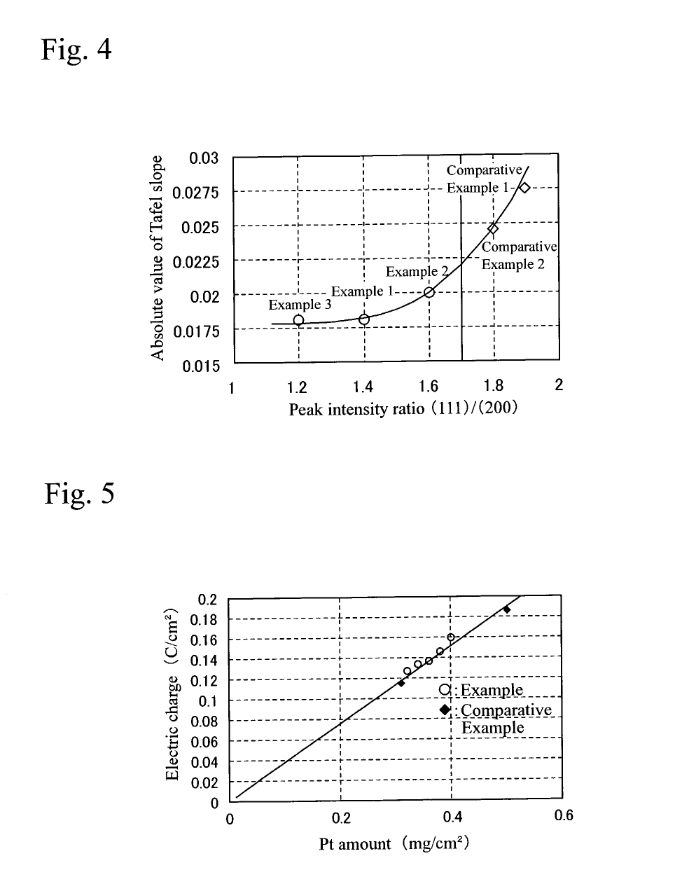

The electrode sheets B of Examples 1 to 3 and Comparative Examples 1 and 2 were transferred to both sides of a polymer electrolyte membrane (of Nafion) by a decal method, and membrane electrode assemblies of Examples 1 to 3 and Comparative Examples 1 and 2 were obtained. Transfer by a decal method is performed by peeling off the FEP sheet after thermal compression bond of the electrode sheet on the polymer electrolyte membrane. On both sides of the obtained membrane electrode assembly, hydrogen gas and air were supplied to generate electric power. The temperature of both the hydrogen gas and the air was 80° C. The utilization rate of hydrogen gas (consumption/supply) was 50%, and the utilization rate of air was 50%. The humidity of hydrogen gas was 50% RH, and the humidity of air was 50% RH. In this power generation, the relationship between the current density and voltage is shown in FIG. 3. The absolute value of the Tafel slope was determined on the basis of the inclination of the range of the current density 0.003 to 0.1 A/cm² in Examples 1 to 3 and Comparative Examples 1 and 2, as described above referring to FIG. 1, and the relationship with the peak intensity ratio I (111)/I (200) was determined. The results are shown in FIG. 4.

As shown in FIG. 4, when the peak intensity ratio I (111)/I (200) exceeds 1.7, the absolute value of the Tafel slope rises suddenly, and this peak intensity ratio is within a range of 1.7 or less in Examples 1 to 3, while it exceeds a range of 1.7 in Comparative Examples 1 and 2. As is apparent from FIG. 3, the power generation performance of Examples 1 to 3 is higher than that of Comparative Examples 1 and 2, and for this reason, it was confirmed that the catalyst activity is high and power generation performance is superior in the range of the peak intensity ratio I (111)/I (200) of 1.7 or less.

Next, the present invention is more specifically described below by referring to membrane electrode assemblies for solid polymer fuel cells in which the present invention is applied.

### EXAMPLE 4

A catalyst paste was obtained by mixing 100 g of ion conductive polymer (trade name: Nafion SE5112, produced by Du Pont Kabushiki Kaisha), and 10 g of platinum carrying carbon particles (trade name: TE10E50E, produced by Tanaka Kikinzoku Kogyo K.K) of carbon black and platinum at a ratio of 50:50 by weight. This catalyst paste was applied and dried on a sheet of FEP (tetrafluoroethylene-hexafluoropropylene copolymer), and an electrode sheet A was obtained. The platinum content in this electrode sheet A was 0.30 mg/cm². Then, 1 g of platinum black (trade name: HiSPEC1000, produced by Johnson Matthey Japan Incorporated) was dissolved in 100 g of purified water, this platinum black solution was sprayed and applied on the electrode sheet A by a spray method, and an electrode sheet B of Example 4 was obtained. The platinum content in this electrode sheet B was 0.40 mg/cm².

### EXAMPLE 5

An electrode sheet B of Example 5 was obtained in the same manner as in Example 4 except that the platinum black solution was sprayed and applied on the electrode sheet A so that the platinum content in the electrode sheet B was 0.38 mg/cm².

### EXAMPLE 6

An electrode sheet B of Example 6 was obtained in the same manner as in Example 4 except that the platinum black solution was sprayed and applied on the electrode sheet A so that the platinum content in the electrode sheet B was 0.36 mg/cm².

### EXAMPLE 7

An electrode sheet B of Example 7 was obtained in the same manner as in Example 4 except that the platinum black solution was sprayed and applied on the electrode sheet A so that the platinum content in the electrode sheet B was 0.34 mg/cm².

### EXAMPLE 8

An electrode sheet B of Example 8 was obtained in the same manner as in Example 4 except that the platinum black solution was sprayed and applied on the electrode sheet A so that the platinum content in the electrode sheet B was 0.32 mg/cm².

### COMPARATIVE EXAMPLE 3

An electrode sheet B of Comparative Example 3 was obtained in the same manner as in Example 4 except that the platinum black solution was sprayed and applied on the electrode sheet A so that the platinum content in the electrode sheet B was 0.31 mg/cm².

### COMPARATIVE EXAMPLE 4

An electrode sheet B of Comparative Example 4 was obtained in the same manner as in Example 4 except that the platinum black solution was sprayed and applied on the electrode sheet A so that the platinum content in the electrode sheet B was 0.50 mg/cm².

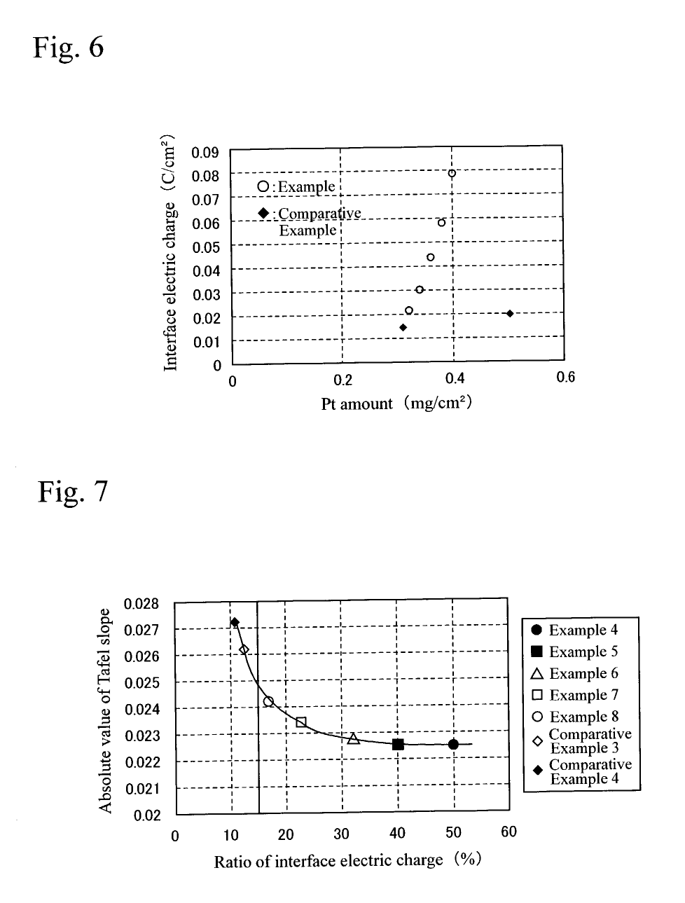

In the electrode sheets B of Examples 4 to 8 and Comparative Examples 3 and 4, the electric charge amount of the catalyst substance was measured by the both-side humidifying method and the one-side humidifying method in the cyclic voltametric method. The electric charge amount in the both-side humidifying method is the electric charge amount of the total catalyst substance, and the electric charge amount in the one-side humidifying method is the electric discharge amount at the interface of the catalyst substance and electrolyte membrane. The measured values by the both-side humidifying method are shown in FIG. 5, and the measured values by the one-side humidifying method are shown in FIG. 6.

Furthermore, the absolute value of the Tafel slope was determined in Examples 4 to 8 and Comparative Examples 3 and 4 on the basis of the inclination of the current density in a range of 0.003 to 0.1 A/cm², as described above referring to FIG. 1. Also in Examples 4 to 8 and Comparative Examples 3 and 4, the ratio of electric charge amount of catalyst substance in the one-side humidifying method to electric charge amount of catalyst substance in the both-side humidifying method was determined, and the relationship of this ratio and the absolute value of the Tafel slope was determined. The results are shown in FIG. 7.

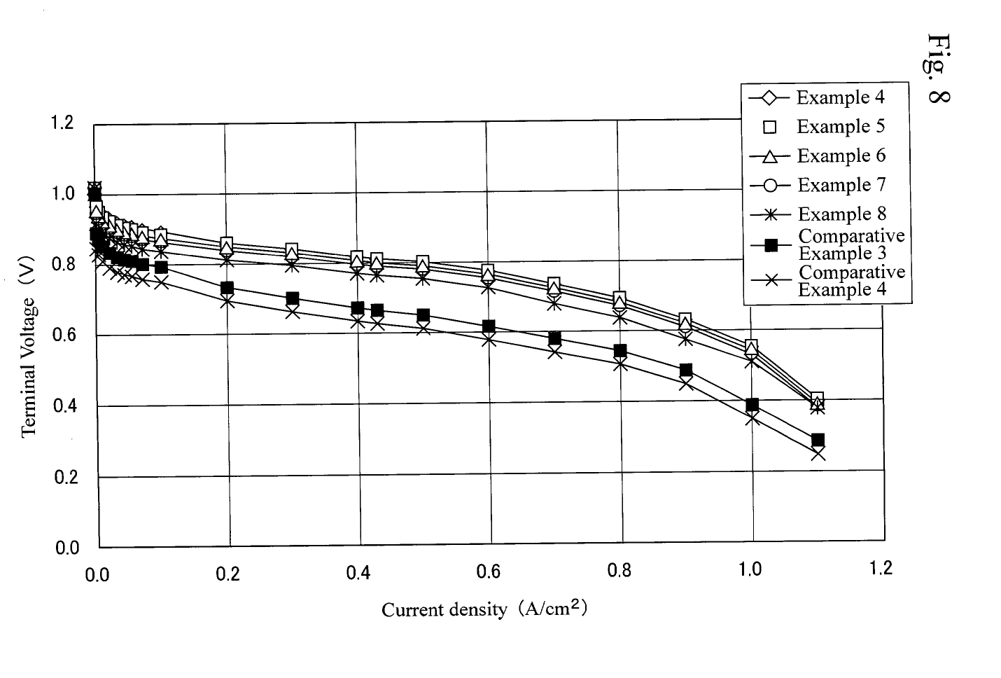

The electrode sheets B of Examples 4 to 8 and Comparative Examples 3 and 4 were transferred on both sides of a polymer electrolyte membrane (of Nafion) by a decal method, and membrane electrode assemblies of Examples 4 to 8 and Comparative Examples 3 and 4 were obtained. Transfer by a decal method is performed by peeling off the FEP sheet after thermal compression bonding of the electrode sheet on the polymer electrolyte membrane. On both sides of the obtained membrane electrode assembly, hydrogen gas and air were supplied to generate electric power. The temperature of both hydrogen gas and air was 80° C. The utilization rate of hydrogen gas (consumption/supply) was 50%, and the utilization rate of air was 50%. The humidity of hydrogen gas was 50% RH, and the humidity of air was 50% RH. In this power generation, the relationship between the current density and voltage is shown in FIG. 8.

As shown in FIG. 5, the total electric charge amount of catalyst substance measured in the both-side humidifying method is proportional to the platinum coating amount. However, as shown in FIG. 6, the interface electric charge amount of catalyst substance measured in the one-side humidifying method was not in proportional relationship to the platinum coating amount, and dropped significantly in Comparative Example 4 with the largest platinum coating amount. Furthermore, as shown in FIG. 7, when the ratio of the interface electric charge amount to the total electric charge amount exceeds 15%, the absolute value of the Tafel slope sharply increases, and the ratio is in a range of 15% or more in Examples 4 to 8, while it is under 15% in Comparative Examples 3 and 4. As is apparent from FIG. 8, the power generation performance of Examples 4 to 8 is higher than in Comparative Examples 3 and 4, and hence it was confirmed that the catalyst activity is high and the power generation performance is superior at the ratio of 15% or more.

What is claimed is:

1. An electrode for solid polymer fuel cells comprising a catalyst substance, electroconductive particles, and an ion conductive polymer, wherein the ratio I (111)/I (200) of peak intensity I (111) of (111) plane and peak intensity I (200) of (200) plane is 1.7 or less when the X-ray diffraction of catalyst substance of the electrode surface is measured.

2. The electrode for solid polymer fuel cells according to claim 1, wherein the catalyst substance is platinum.

3. The electrode for solid polymer fuel cells according to claim 1, wherein the catalyst substance is composed of catalyst substance A supplied before forming of the electrode catalyst layer and catalyst substance B supplied after forming of the electrode catalyst layer.

4. The electrode for solid polymer fuel cells according to claim 2, wherein the catalyst substance is composed of catalyst substance A supplied before forming of the electrode catalyst layer and catalyst substance B supplied after forming of the electrode catalyst layer.

5. The electrode for solid polymer fuel cells according to claim 3, wherein the catalyst substance A is prepared by mixing a catalyst precursor substance, electroconductive particles and ion conductive polymer, and by reducing the catalyst precursor substance chemically, and the catalyst substance B is prepared by spraying and applying a catalyst substance dispersed in aqueous solution on the surface of the electrode catalyst layer.

6. The electrode for solid polymer fuel cells according to claim 4, wherein the catalyst substance A is prepared by mixing a catalyst precursor substance, electroconductive particles and ion conductive polymer, and by reducing the catalyst precursor substance chemically, and the catalyst substance B is prepared by spraying and applying a catalyst substance dispersed in aqueous solution on the surface of the electrode catalyst layer.
